(19) United States
(12) Patent Application Publication
(10) Pub. No.: US 2020/0393254 A1
(43) Pub. Date: Dec. 17, 2020

(54) AUTOMATED SERVICE MANAGEMENT FOR A TRANSPORT

(71) Applicant: TOYOTA MOTOR NORTH AMERICA, INC., Plano, TX (US)

(72) Inventors: Mathew Gardner, Lewisville, TX (US); Joshua C. Batie, Frisco, TX (US); Robert D. Slater, Murphy, TX (US)

(21) Appl. No.: 16/442,052

(22) Filed: Jun. 14, 2019

(51) Int. Cl. G01C 21/34; G06Q 10/02; G06Q 20/38; B60L 58/12; B60L 53/50

(52) U.S. Cl. CPC G01C 21/3415; G06Q 10/02; G01C 21/3438; B60L 58/12; B60L 53/50; G06Q 20/389

(57) ABSTRACT

An example operation may include one or more of monitoring a transport for a condition level status, determining one or more subsequent destination areas for the transport based on a current route, determining a minimum period of time and a service type required to increase the condition level status, identifying one or more service locations for the transport based on the condition status level, the service type and the one or more subsequent destination areas, wherein the one or more service locations have an availability to accommodate the transport for the minimum period of time, and forwarding an updated route to the transport comprising the one or more subsequent destination areas and the one or more service locations.

### TECHNICAL FIELD

This application generally relates to services for transports, and more particularly, to automated service management for a transport.

### BACKGROUND

Vehicles or transports, such as cars, motorcycles, trucks, planes, trains, etc., are generally providing transportation needs to various occupants in a variety of ways. Transports may be identified and utilized by various computing devices, such as a smartphone or a computer.

Transports require regular maintenance, such as a frequent fuel stop, or a less frequent oil change, or other types of maintenance service. Also, service centers offer various products and related items.

### SUMMARY

One example embodiment may provide a method that includes one or more of monitoring a transport for a condition level status, determining one or more subsequent destination areas for the transport based on a current route, determining a minimum period of time and a service type required to increase the condition level status, identifying one or more service locations for the transport based on the condition status level, the service type and the one or more subsequent destination areas, and the one or more service locations have an availability to accommodate the transport for the minimum period of time, and forwarding an updated route to the transport comprising the one or more subsequent destination areas and the one or more service locations.

Another example embodiment includes a system that includes one or more of a transport that is monitored for a condition level status, and a server configured to determine one or more subsequent destination areas for the transport based on a current route, determine a minimum period of time and a service type required to increase the condition level status, identify one or more service locations for the transport based on the condition status level, the service type and the one or more subsequent destination areas, wherein the one or more service locations have an availability to accommodate the transport for the minimum period of time, and forward an updated route to the transport comprising the one or more subsequent destination areas and the one or more service locations.

Still another example embodiment may include a non-transitory computer readable medium comprising instructions, that when read by a processor, cause the processor to perform one or more of monitoring a transport for a condition level status, determining one or more subsequent destination areas for the transport based on a current route, determining a minimum period of time and a service type required to increase the condition level status, identifying one or more service locations for the transport based on the condition status level, the service type and the one or more subsequent destination areas, and the one or more service locations have an availability to accommodate the transport for the minimum period of time, and forwarding an updated route to the transport comprising the one or more subsequent destination areas and the one or more service locations.

Still another example embodiment may include a method that includes one or more of receiving, at a server, a request for a service associated with a transport, the request including an identifier associated with a first user and the transport, and authorizing, by the server, the service when the transport and a device associated with a second user are proximate to an object that provides the service.

Yet a further example embodiment may include a system that includes one or more of a transport associated with a service, and a server that receives a request for the service, the request includes an identifier associated with a first user and the transport, and the service is authorized when the transport and a device associated with a second user are proximate to an object that provides the service.

Still yet another example embodiment may include a non-transitory computer readable medium comprising instructions, that when read by a processor, cause the processor to perform receiving, at a server, a request for a service associated with a transport, the request including an identifier associated with a first user and the transport, and authorizing, by the server, the service when the transport and a device associated with a second user are proximate to an object that provides the service.

### BRIEF DESCRIPTION OF THE DRAWINGS

FIG. 1A illustrates a network diagram of a transport service stop and authentication configuration, according to example embodiments.

FIG. 1B illustrates a blockchain configuration for storing blockchain transaction data, according to example embodiments.

FIG. 1C illustrates a transport charging service procedure, according to example embodiments.

FIG. 2A illustrates an example peer node configuration, according to example embodiments.

FIG. 2B illustrates a shared ledger configuration, according to example embodiments.

FIG. 3A illustrates a transport event monitoring and service setup configuration, according to example embodiments.

FIG. 3B illustrates a flow diagram of a transport service setup configuration, according to example embodiments.

FIG. 3C illustrates flow diagram of a transport service authorization configuration, according to example embodiments.

FIG. 4A illustrates a transport authorization event for a service flow diagram, according to example embodiments.

FIG. 4B illustrates a transport event monitoring and service procedure configuration flow diagram, according to example embodiments.

FIG. 4C illustrates yet another transport event authorization configuration, according to example embodiments.

FIG. 5A illustrates an example blockchain transport configuration, according to example embodiments.

FIG. 5B illustrates another example blockchain transport configuration, according to example embodiments.

FIG. 5C illustrates a further example blockchain transport configuration, according to example embodiments.

FIG. 6 illustrates an example data block, according to example embodiments.

FIG. 7 illustrates an example system that can be used with one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout least this specification refers to the fact that a particular feature, structure, or characteristic described in connection with the embodiment may be included in at one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow. In the current application, a transport may include one or more of cars, trucks, motorcycles, scooters, bicycles, boats, recreational vehicles, planes, and any object that may be used to transport people and or goods from one location to another.

In addition, while the term “message” may have been used in the description of embodiments, the application may be applied to many types of network data, such as, a packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, components, non-transitory computer readable media, devices, and/or networks, which provide at least one of: a transport (also referred to as a vehicle herein) a data collection system, a data monitoring system, a verification system, an authorization system and a vehicle data distribution system. The vehicle status condition data, received in the form of communication update messages, such as wireless data network communications and/or wired communication messages, may be received and processed to identify vehicle/transport status conditions and provide feedback as to the condition changes of a transport. In one example, a user profile may be applied to a particular transport/vehicle to authorize a current vehicle event, service stops at service stations, and to authorize subsequent vehicle rental services.

Within the communication infrastructure, a decentralized database is a distributed storage system which includes multiple nodes that communicate with each other. A blockchain is an example of a decentralized database which includes an append-only immutable data structure (i.e. a distributed ledger) capable of maintaining records between untrusted parties. The untrusted parties are referred to herein as peers, nodes or peer nodes. Each peer maintains a copy of the database records and no single peer can modify the database records without a consensus being reached among the distributed peers. For example, the peers may execute a consensus protocol to validate blockchain storage entries, group the storage entries into blocks, and build a hash chain via the blocks. This process forms the ledger by ordering the storage entries, as is necessary, for consistency. In a public or permission-less blockchain, anyone can participate without a specific identity. Public blockchains can involve cryptocurrencies and use consensus based on various protocols such as proof of work (PoW). On the other hand, a permissioned blockchain database provides a system which can secure interactions among a group of entities which share a common goal, but which do not or cannot fully trust one another, such as businesses that exchange funds, goods, information, and the like. The instant application can function in a permissioned and/or a permissionless blockchain setting.

Smart contracts are trusted distributed applications which leverage tamper-proof properties of the shared or distributed ledger (i.e., which may be in the form of a blockchain) database and an underlying agreement between member nodes which is referred to as an endorsement or endorsement policy. In general, blockchain entries are “endorsed” before being committed to the blockchain while entries which are not endorsed are disregarded. A typical endorsement policy allows smart contract executable code to specify endorsers for an entry in the form of a set of peer nodes that are necessary for endorsement. When a client sends the entry to the peers specified in the endorsement policy, the entry is executed to validate the entry. After validation, the entries enter an ordering phase in which a consensus protocol is used to produce an ordered sequence of endorsed entries grouped into blocks.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits an entry-invocation to an endorser (e.g., peer), and broadcasts entry-proposals to an ordering service (e.g., ordering node). Another type of node is a peer node which can receive client submitted entries, commit the entries and maintain a state and a copy of the ledger of blockchain entries. Peers can also have the role of an endorser, although it is not a requirement. An ordering-service-node or orderer is a node running the communication service for all nodes, and which implements a delivery guarantee, such as a broadcast to each of the peer nodes in the system when committing entries and modifying a world state of the blockchain, which is another name for the initial blockchain entry which normally includes control and setup information.

A ledger is a sequenced, tamper-resistant record of all state transitions of a blockchain. State transitions may result from smart contract executable code invocations (i.e., entries) submitted by participating parties (e.g., client nodes, ordering nodes, endorser nodes, peer nodes, etc.). An entry may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain. There is typically one ledger per channel. Each peer node maintains a copy of the ledger for each channel of which they are a member.

A chain is an entry log which is structured as hash-linked blocks, and each block contains a sequence of N entries where N is equal to or greater than one. The block header includes a hash of the block's entries, as well as a hash of the prior block's header. In this way, all entries on the ledger may be sequenced and cryptographically linked together. Accordingly, it is not possible to tamper with the ledger data without breaking the hash links. A hash of a most recently added blockchain block represents every entry on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain entry log. Because the current state represents the latest key values known to a channel, it is sometimes referred to as a world state. Smart contract executable code invocations execute entries against the current state data of the ledger. To make these smart contract executable code interactions efficient, the latest values of the keys may be stored in a state database. The state database may be simply an indexed view into the chain's entry log, it can therefore be regenerated from the chain at any time. The state database may automatically be recovered (or generated if needed) upon peer node startup, and before entries are accepted.

A blockchain is different from a traditional database in that the blockchain is not a central storage but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like.

Example embodiments provide a way for providing a vehicle service to a particular vehicle and/or requesting user associated with a user profile that is applied to the vehicle. For example, a user may be the owner of a vehicle or the operator of a vehicle owned by another party. The vehicle may require service at certain intervals and the service needs may require authorization prior to permitting the services to be received. Also, service centers may offer services to vehicles in a nearby area based on the vehicle's current route and a relative level of service requirements (e.g., immediate, severe, intermediate, minor, etc.). The vehicle needs may be monitored via one or more sensors which report sensed data to a central controller computer device in the vehicle, which in turn, is forwarded to a management server for review and action.

A sensor may be located on one or more of the interior of the transport, the exterior of the transport, on a fixed object apart from the transport, and on another transport near to the transport. The sensor may also be associated with the transport's speed, the transport's braking, the transport's acceleration, fuel levels, service needs, the gear-shifting of the transport, the transport's steering, and the like. The notion of a sensor may also be a device, such as a mobile device. Also, sensor information may be used to identify whether the vehicle is operating safely and whether the occupant user has engaged in any unexpected vehicle conditions, such as during the vehicle access period. Vehicle information collected before, during and/or after a vehicle's operation may be identified and stored in a transaction on a shared/distributed ledger, which may be generated and committed to the immutable ledger as determined by a permission granting consortium, and thus in a “decentralized” manner, such as via a blockchain membership group. Each interested party (i.e., company, agency, etc.) may want to limit the exposure of private information, and therefore the blockchain and its immutability can limit the exposure and manage permissions for each particular user vehicle profile. A smart contract may be used to provide compensation, quantify a user profile score/rating/review, apply vehicle event permissions, determine when service is needed, identify a collision and/or degradation event, identify a safety concern event, identify parties to the event and provide distribution to registered entities seeking access to such vehicle event data. Also, the results may be identified, and the necessary information can be shared among the registered companies and/or individuals based on a “consensus” approach associated with the blockchain. Such an approach could not be implemented on a traditional centralized database.

The instant application includes, in certain embodiments, authorizing a vehicle for service via an automated and quick authentication scheme. For example, driving up to a charging station or fuel pump may be performed by a vehicle operator and the authorization to receive charge or fuel may be performed without any delays provided the authorization is received by the service station. A vehicle may provide a communication signal that provides an identification of a vehicle that has a currently active profile linked to an account that is authorized to accept a service which can be later rectified by compensation. Additional measures may be used to provide further authentication, such as another identifier may be sent from the user's device wirelessly to the service center to replace or supplement the first authorization effort between the transport and the service center with an additional authorization effort.

Data shared and received may be stored in a database which maintains data in one single database (e.g., database server) and generally at one particular location. This location is often a central computer, for example, a desktop central processing unit (CPU), a server CPU, or a mainframe computer. Information stored on a centralized database is typically accessible from multiple different points. A centralized database is easy to manage, maintain, and control, especially for purposes of security because of its single location. Within a centralized database, data redundancy is minimized as a single storing place of all data also implies that a given set of data only has one primary record.

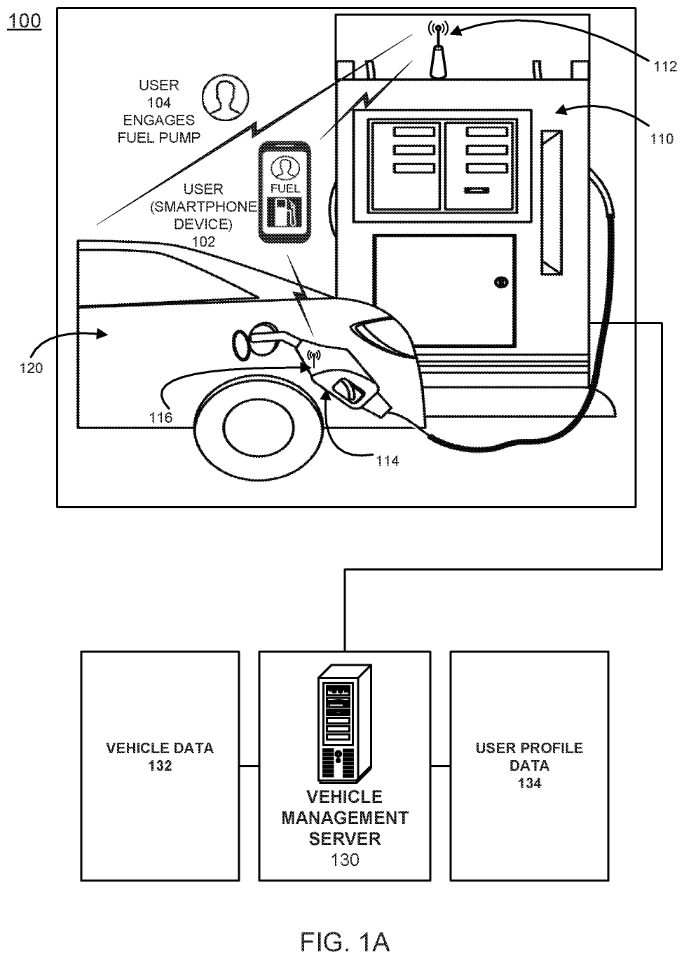

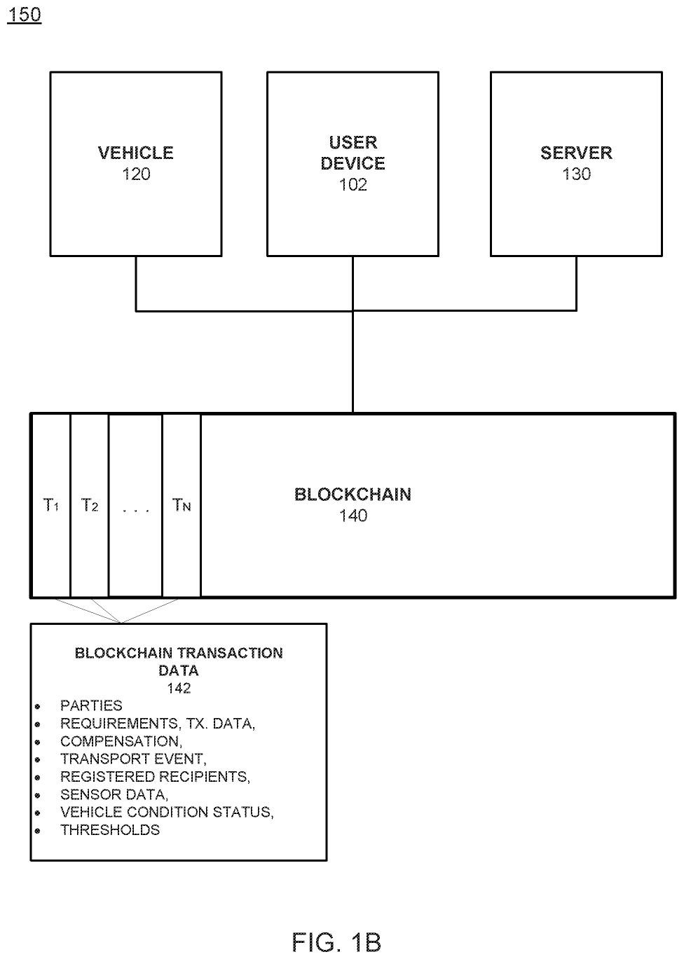

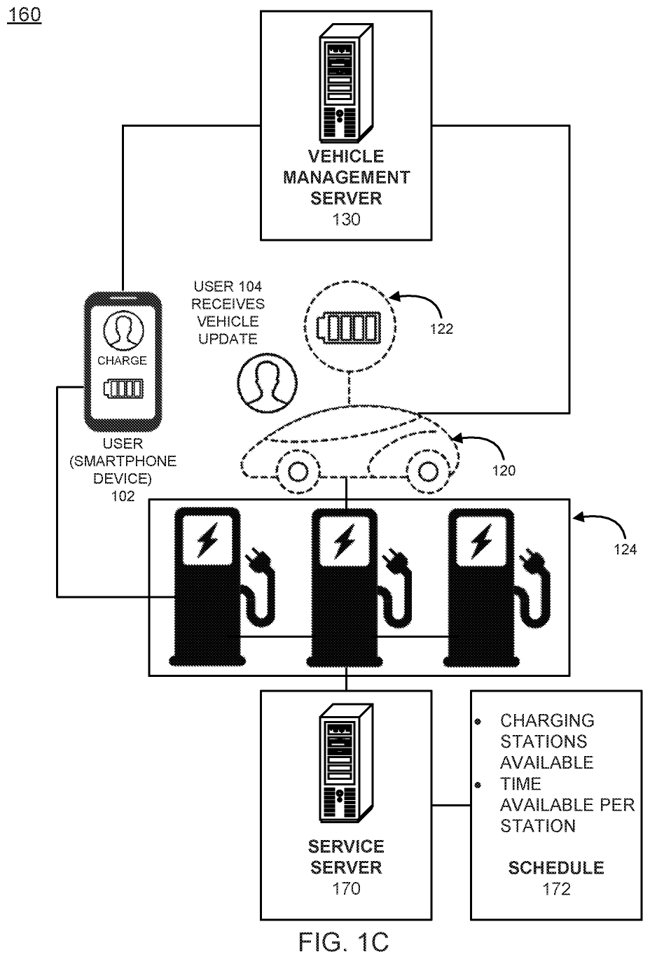

FIG. 1A illustrates a network diagram of a transport accessing a service center location, according to example embodiments. Referring to FIG. 1A, the network diagram 100 includes a user 104 operating a transport 120 and a user device 102 to request access to a vehicle service, such as a charge for an electric vehicle or fuel for a standard vehicle. The vehicle 120 may be a rented, owned, partially owned (i.e., subject to other owners), autonomously driven by a non-present driver, semi-autonomously driven by a driver or driven by a conventional manual vehicle operator. In operation, the vehicle 120 may drive up to a service center fuel/charge pump station 110 and communicate via a wireless communication to a radio receiver 112 integrated as a communication point for the station 110, which may also have a computer and other processing entities.

During an initial setup for a service session, the vehicle 120 may pass within a predefined distance of the service station 110 (e.g., 5 feet). The vehicle may emit a signal wirelessly to initiate a request for a service (i.e., fuel/charge) associated with a transport, the request includes an identifier associated with a first user and the transport. The identifier may be an encrypted user profile associated with a distributed ledger and/or an encryption key. The service station 110 may receive the signal via a wireless transceiver 112 and process the information via a computing device that identifies and authorizes the vehicle with a first user. A remote server 130 may require an identifier from the user device 102 as well as a second form of identification. The user device 102 may belong to a trusted part of the vehicle owner, such as a child, friend, etc.

The device 102 may be identified when the device is proximate to an object, such as the service station 100 which can communicate directly with the device 102 to receive another key or identifier prior to providing the service. When the transport 120 and/or the device 102 are proximate to the service station 110, the first identifier (FI) may be forwarded via a communication between the transport 120 and the service location 110. A second communication may take place between the user device 102 and the service location 110, which includes a second identifier (SI). The second identifier may identify the user device 102 as an authorized user of the vehicle owned or managed by the first user. The FI may be transferred and verified and then a time frame, such as 20 seconds may start counting to identify whether the SI has been received prior to the time frame expiring. If the SI is identified via a close communication within the time frame, the authorization may be approved. Additionally, a message may be sent to the first user device (not shown) and may require an authorization response, such as acceptance of the particular service event by the first user's device within the predefined time period, prior to authorizing the current service event via the service station 110. The information received may be forwarded to a server 130 for authorization based on known vehicle data 132, which may identify the vehicle and user profile data 134, which may identify the user(s). In another example, a second transceiver 116 may be installed on the charge/fuel device handle 114 to identify the user device 102 as a secondary authorization measure for receiving the one or more identifiers sent from the transport and/or the user device 102.

Once the authorization is completed, the service may be rendered and compensation may be forwarded in the form of a blockchain transaction from the vehicle, the service station 110, etc., to the vehicle management server 130 for commitment to a blockchain. The transaction may include details of the authorization requirements, such as one identifier, a second identifier, a time frame for receiving the second identifier after the first identifier, compensation, etc. The process may also include invoking a smart contract stored in the distributed ledger responsive to the authorizing of the service, and the smart contract may include information related to at least one of the server, the request, the service, the transport, the identifier(s), the first user, the user device, the second user, and the object/station, which may be committed to a transaction in the distributed ledger, which may store any of those information articles and/or a date of the service, a location of the service, a time of the service, and a payment for the service.

In another example, any of a number of vehicles identified as potential vehicles for a service event may be identified by service need sensors, such as those which detected when fuel/charge is low, the vehicle needs a service (e.g., tire change, oil change, engine service, etc.) The sensors may be hardwired to a central controller, or on-board transport computer, or other processor associated with the vehicle, or may instead be providing wireless communications with the central controller of the vehicle's computer via various wireless communication protocols. The data may be transmitted from the central controller/computer, a user's smartphone 102, and/or via a cellular compatible device, etc. The sensor content and different sensor data types may include one or more of a radio station selection, recorded audio, mobile device usage within the vehicle, telephone calls conducted inside the vehicle, browser history of at least one of the computing devices, purchases conducted via at least one computing device inside the vehicle, movement of the vehicle, navigation of the vehicle, a collision of the vehicle, speed of the transport, acceleration of the vehicle, diagnostics associated with the transport including battery charge level, gasoline level, oil level, temperature of the vehicle, location of the vehicle, detected traffic near the vehicle, information regarding other vehicles, etc. The sensor data may be collected and stored for analysis and transaction recording.

The types of sensors which may be included with the vehicles may include one or more of movement sensors, sonar sensors, lidar sensors, accelerometers, touch sensors, proximity sensors, temperature sensors, speed sensors, sound sensors, infrared sensors, collision sensors, level sensors, tire pressure sensors, location determination sensors, ultrasonic sensors, camera sensors, activity sensors, chemical sensors, fluid sensors, pressure sensors, optical sensors, biometric sensors, and the like.

As noted previously, the vehicle 120 may be a vehicle operated by a human driver or an autonomous vehicle operated by a computer and/or remote agent designed for users to ride in during a transport event. The vehicle sensor data may be collected via a plurality of the vehicle sensors. The controller device (i.e., on-board computer and/or user smartphone, etc.) may identify the sensor type, sensor identifier and instances of sensor data received for those parameters. The collection of sensor data may create one or more sets of sensor data. For example, sensors S1, S2, S3 . . . Sn, may generate sensor data sets SD1, SD2, SD3 . . . SDn. Those sensor data sets may include multiple iterations of sensor data over a fixed period of time (e.g., milliseconds, seconds, minutes, hours, etc.) or short instances of extreme measurements, such as only instances of large deviations from expected values to identify, for example, an accident, a hole in the road, braking, extreme conditions or maneuvers, the need for service, etc.

Owners of autonomous/non-autonomous vehicles (or occupants of the vehicles) may register their personal profiles in a shared distributed ledger or other data management system so the information collected during sensor collection efforts may be shared. The smart contract may identify the parties of the agreement, permissions for vehicle occupants, types of data, current profile statuses, sensor thresholds associated with vehicle damages/liability and service needs, and other parameters. The immutability of the sensor data may also be preserved via the shared ledger format of a blockchain.

FIG. 1B illustrates a blockchain configuration for storing blockchain transaction data, according to example embodiments. Referring to FIG. 1B, the example configuration 150 provides for the vehicle 120, the user device 102 and a server 130 sharing information with a distributed ledger (i.e., blockchain) 140. The server may represent a service provider entity inquiring with a vehicle service provider to share user profile rating information in the event that a known and established user profile is attempting to rent a vehicle with an established rated profile. The server 130 may be receiving and processing data related to a vehicle's service requirements. As the service events occur, such as the vehicle sensor data indicates a need for fuel/charge, a maintenance service, etc., a smart contract may be used to invoke rules, thresholds, sensor information gathering, etc., which may be used to invoke the vehicle service event. The blockchain transaction data 142 is saved for each transaction, such as the access event, the subsequent updates to a vehicle's service status, event updates, etc. The transactions may include the parties, the requirements (e.g., 18 years of age, service eligible candidate, valid driver's license, etc.), compensation levels, the distance traveled during the event, the registered recipients permitted to access the event and host a vehicle service, rights/permissions, sensor data retrieved during the vehicle event operation to log details of the next service event and identify a vehicle's condition status, and thresholds used to make determinations about whether the service event was completed and whether the vehicle's condition status has changed.

FIG. 1C illustrates a transport charging service procedure, according to example embodiments. Referring to FIG. 1C, the configuration 160 includes the user 104 having access to a vehicle, such as, for example via a rental service managed via the smartphone 102. The transport 120 may be operated by a current user 104 operating a smartphone device 102. The vehicle management server 110 may receive updates about the vehicle's status, such as a current charge rating 122 indicating the amount of battery the vehicle currently has stored. A service need may be created as an alert to the current vehicle operator and a respective device 102. The service need may be an alert that is automatically generated based on various parameters, such as whether the operator 104 is identified as a service member qualified to manage the service, the degree of service need (e.g., 1 out of 10), depending on the number of service needs, a magnitude of the service needs (e.g., battery is at a 1 out of a possible 10 charge level), whether service is obtainable based on service locations, etc., and/or a current vehicle need, for example, if the vehicle is not headed home to be charged and is expected to travel to a next destination based on a current event plan, then the next step may be invoke service via the most appropriate service station.

In this example, the nearest charging station 124 may have a plurality of charging stations. One of those stations can be reserved ahead of time for a short period of time to ensure the vehicle operators are not forced to wait for another vehicle to finish. The decision to identify and register the vehicle 120 with the charging station 124 may be based on a current route for the transport (e.g., additional stops being made in the near future), a current need for charge being greater than average (e.g., less than 10 percent charge remaining), and the availability in general of the user's schedule and the transport station 124. The service station 124 may have a management service server 170 which is responsible for managing the schedule, the transactions and the time required to satisfy the service requests. The data may include, for example, the charging station schedule, such as those which are available and a time period of availability per each station 172. In one example, a full charge may require one hour of charge time at a particular station, and the vehicle may be five minutes away and require a 90 percent charge to full charge status, however, the user may have an appointment in 45 minutes, and thus the charge time may be calculated for a half charge event. The amount of charge administered can be identified and used as the basis for a compensation level owed by the vehicle to the service center.

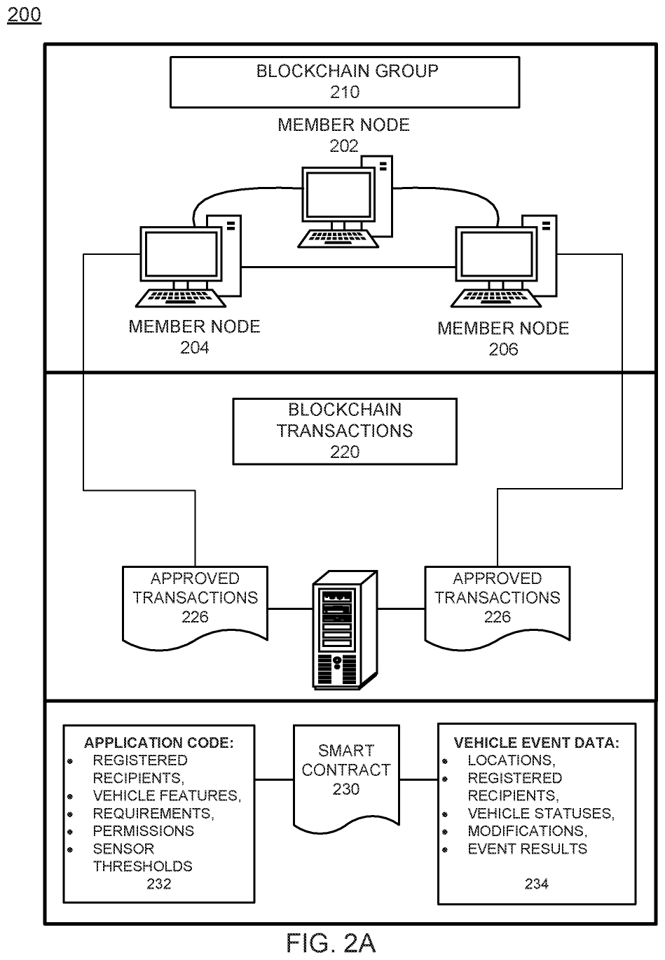

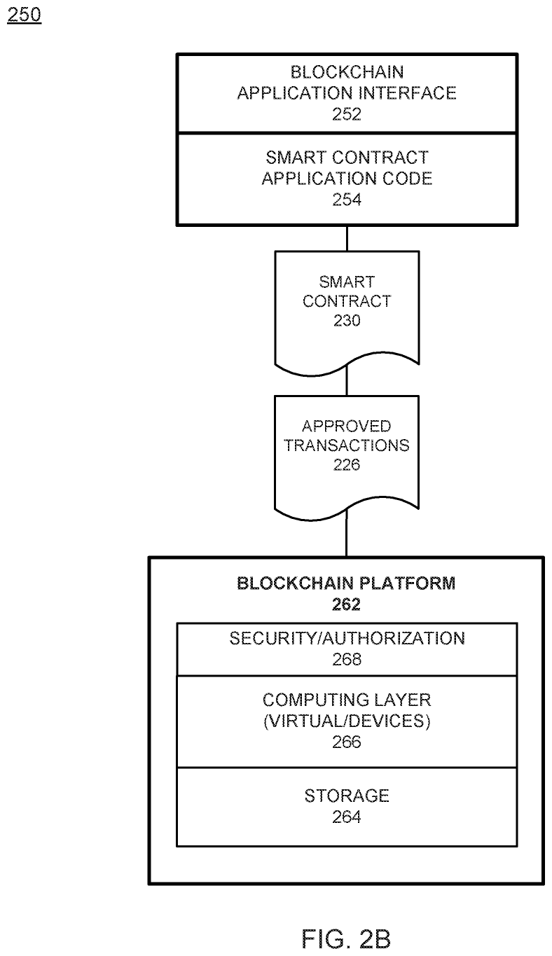

FIG. 2A illustrates a blockchain architecture configuration 200, according to example embodiments. Referring to FIG. 2A, the blockchain architecture 200 may include certain blockchain elements, for example, a group of blockchain member nodes 202-206 as part of a permissioned blockchain group 210. The permissioned blockchain is not accessible to all parties but only to those members with permissioned access to the blockchain data. The blockchain nodes participate in a number of activities, such as blockchain entry addition and validation process (consensus). One or more of the blockchain nodes may endorse entries based on an endorsement policy and may provide an ordering service for all blockchain nodes. A blockchain node may initiate a blockchain action (such as an authentication) and seek to write to a blockchain immutable ledger stored in the blockchain, a copy of which may also be stored on the underpinning physical infrastructure.

The blockchain transactions 220 are stored in memory of computers as the transactions are received and approved by the consensus model dictated by the members' nodes. Approved transactions 226 are stored in current blocks of the blockchain and committed to the blockchain via a committal procedure which includes performing a hash of the data contents of the transactions in a current block and referencing a previous hash of a previous block. Within the blockchain, one or more smart contracts 230 may exist that define the terms of transaction agreements and actions included in smart contract executable application code 232. The code may be configured to identify whether requesting entities are registered to receive vehicle services, what service features they are entitled/required to receive given their profile statuses and whether to monitor their actions in subsequent events. For example, when a service event occurs and a user is riding in the vehicle, the sensor data monitoring may be triggered, and a certain parameter, such as a vehicle charge level, may be identified as being above/below a particular threshold for a particular period of time, then the result may be a change to a current status which requires an alert to be sent to the managing party (i.e., vehicle owner, vehicle operator, server, etc.) so the service can be identified and stored for reference. The vehicle sensor data collected may be based on types of sensor data used to collect information about vehicle's status. The sensor data may also be the basis for the vehicle service event data 234, such as a location(s) to be traveled, an average speed, a top speed, acceleration rates, whether there were any collisions, was the expected route taken, what is the next destination, whether safety measures are in place, whether the vehicle has enough charge/fuel, etc. All such information may be the basis of smart contract terms 230, which are then stored in a blockchain. For example, sensor thresholds stored in the smart contract can be used as the basis for whether a detected service is necessary and when and where the service should be performed.

FIG. 2B illustrates a shared ledger configuration, according to example embodiments. Referring to FIG. 2B, the blockchain logic example 250 includes a blockchain application interface 252 as an API or plug-in application that links to the computing device and execution platform for a particular transaction. The blockchain configuration 250 may include one or more applications which are linked to application programming interfaces (APIs) to access and execute stored program/application code (e.g., smart contract executable code, smart contracts, etc.) which can be created according to a customized configuration sought by participants and can maintain their own state, control their own assets, and receive external information. This can be deployed as an entry and installed, via appending to the distributed ledger, on all blockchain nodes.

The smart contract application code 254 provides a basis for the blockchain transactions by establishing application code which when executed causes the transaction terms and conditions to become active. The smart contract 230, when executed, causes certain approved transactions 226 to be generated, which are then forwarded to the blockchain platform 262. The platform includes a security/authorization 268, computing devices which execute the transaction management 266 and a storage portion 264 as a memory that stores transactions and smart contracts in the blockchain.

The blockchain platform may include various layers of blockchain data, services (e.g., cryptographic trust services, virtual execution environment, etc.), and underpinning physical computer infrastructure that may be used to receive and store new entries and provide access to auditors which are seeking to access data entries. The blockchain may expose an interface that provides access to the virtual execution environment necessary to process the program code and engage the physical infrastructure. Cryptographic trust services may be used to verify entries such as asset exchange entries and keep information private.

The blockchain architecture configuration of FIGS. 2A and 2B may process and execute program/application code via one or more interfaces exposed, and services provided, by the blockchain platform. As a non-limiting example, smart contracts may be created to execute reminders, updates, and/or other notifications subject to the changes, updates, etc. The smart contracts can themselves be used to identify rules associated with authorization and access requirements and usage of the ledger. For example, the information may include a new entry, which may be processed by one or more processing entities (e.g., processors, virtual machines, etc.) included in the blockchain layer. The result may include a decision to reject or approve the new entry based on the criteria defined in the smart contract and/or a consensus of the peers. The physical infrastructure may be utilized to retrieve any of the data or information described herein.

Within smart contract executable code, a smart contract may be created via a high-level application and programming language, and then written to a block in the blockchain. The smart contract may include executable code which is registered, stored, and/or replicated with a blockchain (e.g., distributed network of blockchain peers). An entry is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A smart contract executable code may include the code interpretation of a smart contract, with additional features. As described herein, the smart contract executable code may be program code deployed on a computing network, where it is executed and validated by chain validators together during a consensus process. The smart contract executable code receives a hash and retrieves from the blockchain a hash associated with the data template created by use of a previously stored feature extractor. If the hashes of the hash identifier and the hash created from the stored identifier template data match, then the smart contract executable code sends an authorization key to the requested service. The smart contract executable code may write to the blockchain data associated with the cryptographic details.

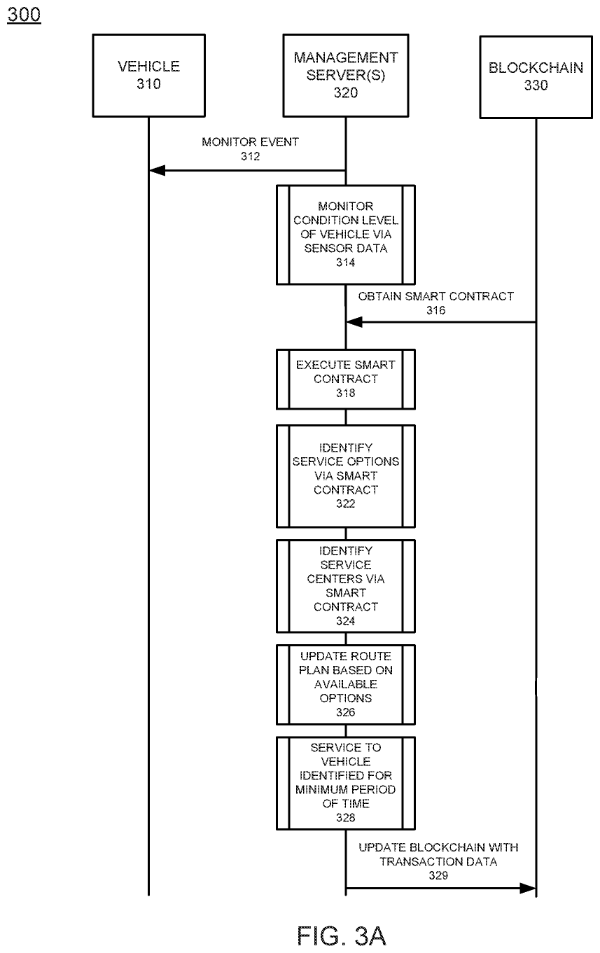

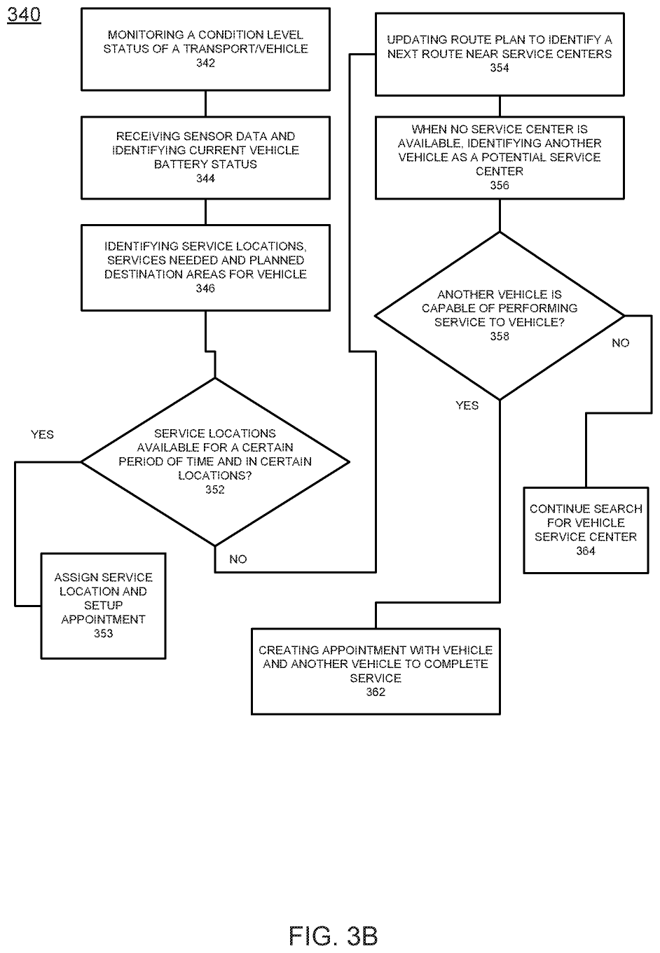

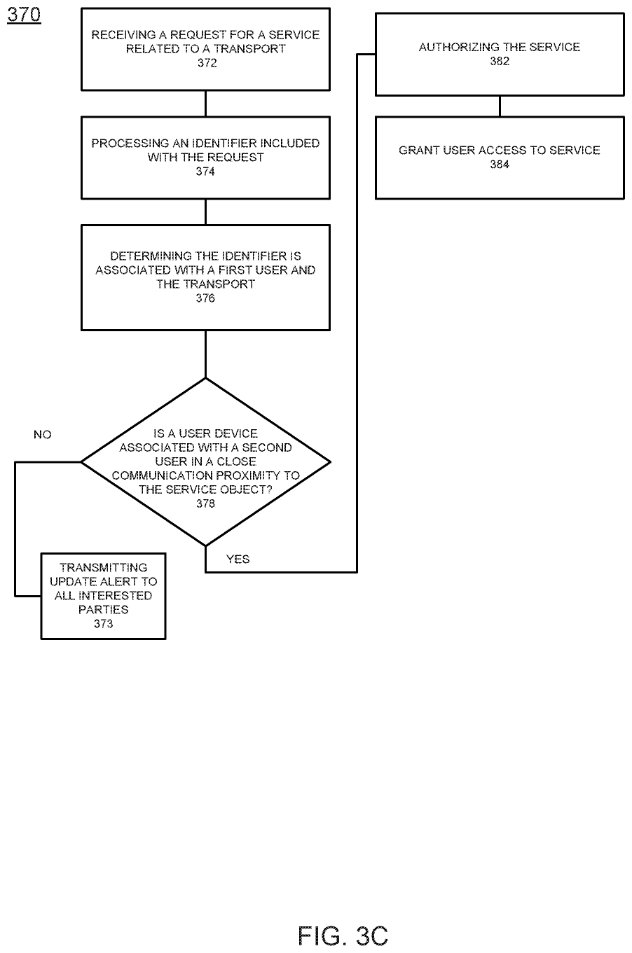

FIG. 3A illustrates a transport service management system configuration, according to example embodiments. Referring to FIG. 3A, the system 300 provides a transport/vehicle 310, which may be requested, accessed and operated via a user submitted request to initiate a vehicle event, which is then monitored 312 for event status, which may be managed by a management server 320. The server 320 may identify a particular vehicle 310 being requested, used and encountering service needs, such as one owned by a user, or one that is selected for purchase, rent, or is available for rental/taxi purposes. The user profile of the requesting entity may also be retrieved to apply to the vehicle 310 along with a set of defined vehicle features which are required/prohibited during operation. The procedure for accessing and receiving a vehicle may be managed by an obtained smart contract 316 associated with a blockchain 330. The ongoing monitoring of the condition level of the vehicle may be based on sensor data 314. The sensor data may provide periodic updates to the server 320 to indicate a likely service need in the near future.

The smart contract may be executed 318 to enable a new vehicle monitor event. The vehicle that is ideal for such an event may be identified as available, and a user device may be notified of the new event and any necessary updates. This process may load the user's profile on the vehicle and/or a customized vehicle event file that includes service requirements, conditions, etc., retrieved from the user's profile and which are applied to a vehicle computer, via the smart contract 322, so the correct conditions are monitored by the central vehicle controller and the remote management server 320. During operation, such as once the user has started moving with the vehicle, any newly detected conditions (e.g., service needs) may be identified and then paired with service centers that can assist with those service needs 324. Such information may be identified and stored in a temporary profile file for subsequent reporting of the vehicle status. For example, when the vehicle identifies a sensor based detection of a low battery condition (sensor data exceeds/falls below known threshold(s)), the data is collected and used to populate the temporary service profile. When an analysis is performed to identify service centers based on location, service center availability, time required to alleviate the service needs and/or current route (future routes) of transport, the current route may be modified to create a new route 326 which includes the service stop. The minimum period of time may be applied to the service plan to determine whether the service is sufficient for the current route (e.g., charge for at least 30 minutes). The result of the determination may be a confirmation that the vehicle received a charge for the minimum period of time 328. All updates are stored in the blockchain 330 via new data transactions 329. In another embodiment, the payment for the renting of the object, such as a transport, is governed and/or occurs in the smart contract.

FIG. 3B illustrates a flow diagram of a transport service setup configuration, according to example embodiments. Referring to FIG. 3B, the example method 340 includes monitoring a condition level status of a transport/vehicle 342, which may be any of a large number of vehicle sensed conditions identified via sensors installed on the vehicle. The sensor data may be obtained by the vehicle computing device installed on the vehicle or via a user smartphone operating inside or near the vehicle. In one example, the battery level of the vehicle is obtained 344 and compared to known values associated with a condition status which may be dependent on the vehicle's current operational status, such as a route. The determination as to whether the vehicle can continue servicing passengers or must obtain service is performed based on thresholds of time, sensed conditions, and the current route. The determination of a service need may cause identifying of service locations 346 that can provide the service needs for a particular service route (e.g., on the way to a next destination). The next operation may include a determination as to the service locations available and for how long a period of time the availability may be available 352. If the needed amount of time of service is not available in a current location area (e.g., a five/ten mile radius of the vehicle), a next location may be identified as another service center 354. If the service center identified can accommodate the service, it may be assigned to that location similar to an appointment 353 so the service station is available when needed.

In the event no service center is available, then another vehicle may be identified as a potential mobile service option, such as a new route may indicate that the vehicle in need of service may meet the available vehicle to perform a vehicle-to-vehicle service 356. In one example, may be a drop-off of passengers, where one vehicle waits or travels to a location where another vehicle is present, and the passengers with the demanding route (e.g., new locations to visit), can then change vehicles while the first vehicle seeks service. Another option may be to have the second vehicle provide the service, such as a charge between vehicles, for a period of time that is sufficient to provide the first vehicle with enough charge to move towards the next destination in the route, identify other service centers and resume the service stop at a later time. The vehicle providing the service must be capable of satisfying the service needs, such a determination may be necessary prior to creating such an appointment 358. For example, a registered service vehicle may perform a drop-off and then be selected to perform the service assuming the vehicle owner is registered to perform vehicle services. In that case, the appointment can be setup automatically to have the service vehicle meet with the service needing vehicle so the service can be performed 362. If no vehicle can perform the service at that time, the search continues 364 for another service center option.

FIG. 3C illustrates flow diagram of a transport service authorization configuration, according to example embodiments. Referring to FIG. 3C, the example method 370 provides an example of a vehicle engaging a service center via an autonomous service. For example, as the transport arrives at a service station, such as a fueling station, the transport may transmit a wireless identifier signal that requests service from that station 372, the request may include an identifier 374, such as a user identifier, encryption key, etc., that identifies the vehicle owner and the vehicle as reputable service recipients that provide compensation or have a credit profile that indicates the owner as a trusted entity. The identifier may be identified as being associated with the owner 376 of the transport and a primary party capable of authorizing other subordinate users of the vehicle. The identifier may also indicate the vehicle is not stolen or is in an optimal status at the current time as the vehicle may be operated by another user, such as a renter, a borrower, a family member, etc. As the vehicle is in communication with the service station, the user operating the vehicle may step-out to hookup a gas or charge pump to the vehicle. The user's smartphone may provide a secondary from of authentication, for example, the user may be a registered renter of the vehicle and his or her credentials may also be checked when the user's phone is in close proximity to the service station or the service station pump handle 378. If the credentials are checked via a second identifier, key or other information type, and the user is not authorized or requires authorization, an alert may be sent 373 to the primary vehicle owner for authorization. Once the necessary authorization is made 382, the service may be authenticated, and the user may then receive charge/fuel or whatever service needs are available 384.

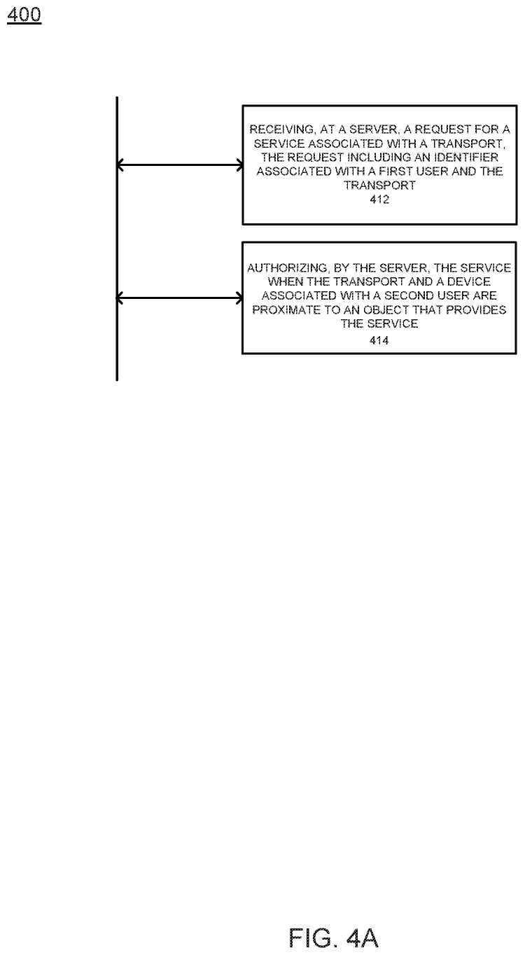

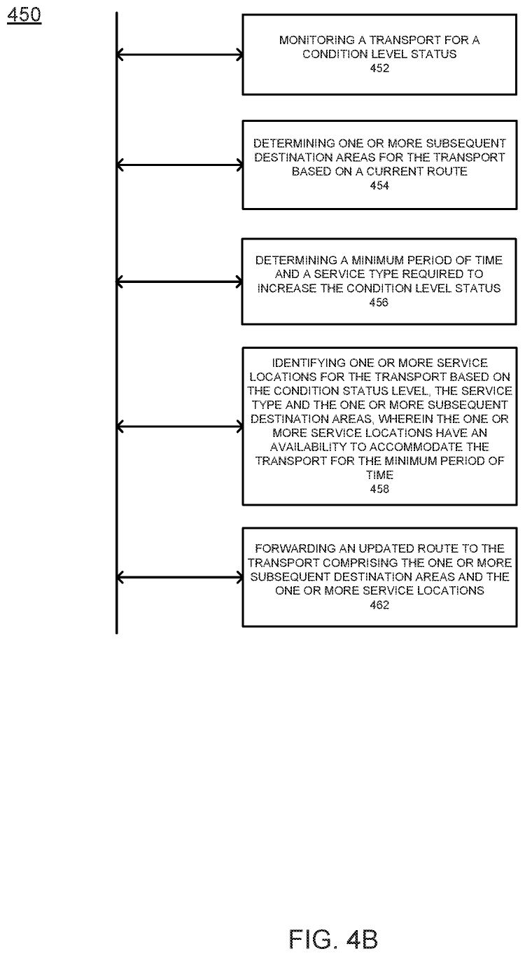

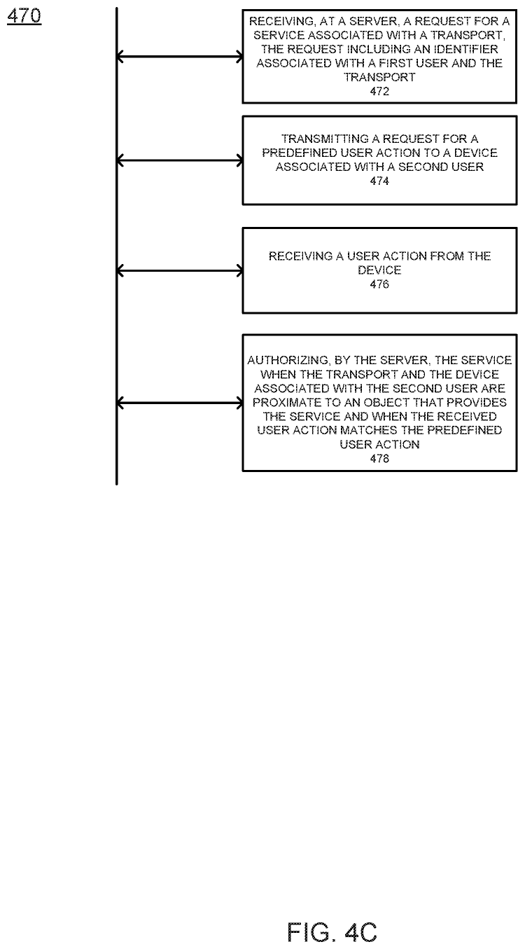

FIG. 4A illustrates a transport authorization event for a service flow diagram, according to example embodiments. Referring to FIG. 4A, the process 400 may include one or more of receiving, at a server, a request for a service associated with a transport, the request including an identifier associated with a first user and the transport 412. This operation may be a transport arriving and communicating with a service station, such as in the example of a request for fuel/charge services. The identifier may be a key certificate that authorizes the user for service via a wireless communication signal. The process may also include authorizing, by the server, the service when the transport and a device associated with a second user are proximate to an object that provides the service 414. In this operation, the authorization may require a second stage of authentication, such as identifying the user device as a trusted operator of the vehicle under the vehicle owner's pre-authorization. For example, the user device may belong to a child of the vehicle owner and may be registered in the vehicle profile of the vehicle that is used to access the service station.

There may be a wireless communication module in the service station and/or the service station pump handle which authorizes the service based on when the transport and the device are proximate to one another, such as 3-5 feet in distance. In another example, the process may include determining that the identifier is associated with the second user and the first user, and thus an authorization of the second user can be performed. Another example may include authorizing payment for the service by at least one of the device and the server. The request may be sent from the device. The process may also include invoking a smart contract stored in a distributed ledger responsive to the authorizing of the service, the smart contract may include information related to at least one of the server, the request, the service, the transport, the identifier, the first user, the device, the second user, and the object, and the distributed ledger may be stored in the server, in the service station and/or in the transport. The smart contract may identify and have terms or rules for any or more of a date of the service, a location of the service, a time of the service, and a payment for the service. The transport may be a transport which may be rented, such as car, van, truck, motorcycle, RV, water vehicle, scooter, bicycle, and any object that may be used to transport people and or goods from one location to another.

FIG. 4B illustrates a transport event monitoring and service procedure configuration flow diagram, according to example embodiments. Referring to FIG. 4B, the process 450 may include one or more of monitoring a transport for a condition level status 452, such as through sensor data, or other monitoring procedures. The process may also include determining one or more subsequent destination areas for the transport based on a current route 454 to identify where the vehicle is currently headed and where the vehicle is going in the future. The may also include determining a minimum period of time and a service type required to increase the condition level status 456, this may be, for example, how much time it will take to charge the vehicle to a battery charge level that will permit the vehicle to move on to the next destination in the event the battery is low. For example, it may take 30 minutes of charging to prepare the vehicle for its next planned navigation route destination. It may take 45 minutes of charging to ensure the vehicle is ready for the next two stops on the current route. The process may also include identifying one or more service locations for the transport based on the condition status level, the service type and the one or more subsequent destination areas, and the one or more service locations have an availability to accommodate the transport for the minimum period of time 458, and forwarding an updated route to the transport including the one or more subsequent destination areas and the one or more service locations 462. The route may now include the service stop and adjusted times for each destination due to the modification to include the service in the plan.

The process may also include receiving sensor data indicating a current battery level of a battery of the transport, determining the condition level status, associated with the current battery level, is below a minimum threshold required for the transport to travel to a destination among the one or more subsequent destination areas identified in the current route, determining the minimum period of time is required to charge the transport to a new battery level required to travel to the destination, and selecting a service location among the one or more service locations which has availability for the transport to charge its battery for the minimum period of time. If a service location is near the transport at the current time or at a near term future anticipated location and time, then that service center and its location may be a candidate service center to assist with vehicle service.

The method may also include transmitting a reservation request to the one or more service locations for the transport to arrive at an estimated time, receiving a confirmation from a service location among the one or more service locations which has availability for the transport to charge its battery for the minimum period of time, and responsive to receiving the confirmation, creating the updated route including the service location as a next destination. The method may also include identifying another transport with a higher charge level than a charge level of the transport, determining the another transport has a currently availability for a transport-to-transport charging session for the minimum period of time, assigning the another transport as a designated service location, and creating the updated route to include the another transport's location or a meetup location where the transport and the another transport will meet, as a next destination for the transport. The method may also include receiving a transport charge from the another transport for the minimum period of time, and creating a transaction comprising a compensation to the another transport, retrieving a smart contract from a distributed ledger, identifying a compensation value from the smart contract for a charge service. The method may also include storing the blockchain transaction in the distributed ledger and creating a blockchain transaction when a charge service for the transport is completed, the blockchain transaction having parties to the transaction, a period of time of the transaction, a location and the compensation value.

FIG. 4C illustrates yet another transport event authorization configuration, according to example embodiments. Referring to FIG. 4C, the process 470 may also include one or more of receiving 472, at a server, a request for a service associated with a transport, the request including an identifier associated with a first user and the transport and transmitting a request for a predefined user action to a device associated with a second user 474. The predefined user action may be a gesture, a confirmation, a passcode, or any known authentication technique to confirm the user knows the action and performs it when prompted to do make the action. The method may also include receiving a user action from the device 476, authorizing, by the server, the service when the transport and the device associated with the second user are proximate to an object that provides the service and when the received user action matches the predefined user action 478. The received user action may be interpreted and compared to the known user action for similarity analysis to confirm the user has knowledge of the additional security measure, such as moving their smartphone is a figure-8 movement sequence while at the service station interface, etc. This action is captured and stored in memory and compared to the known user action for authentication.

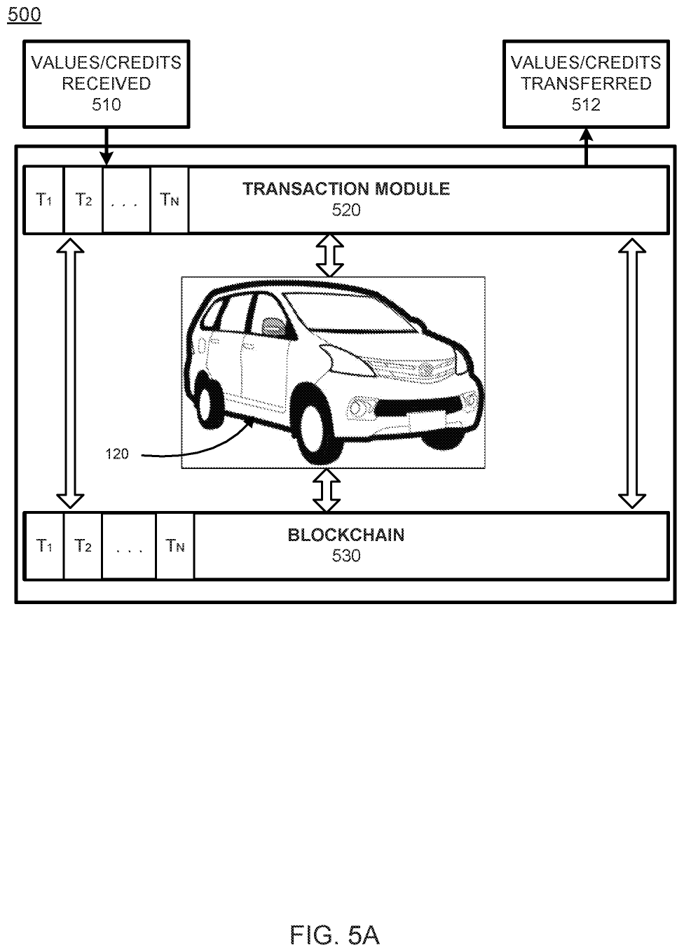

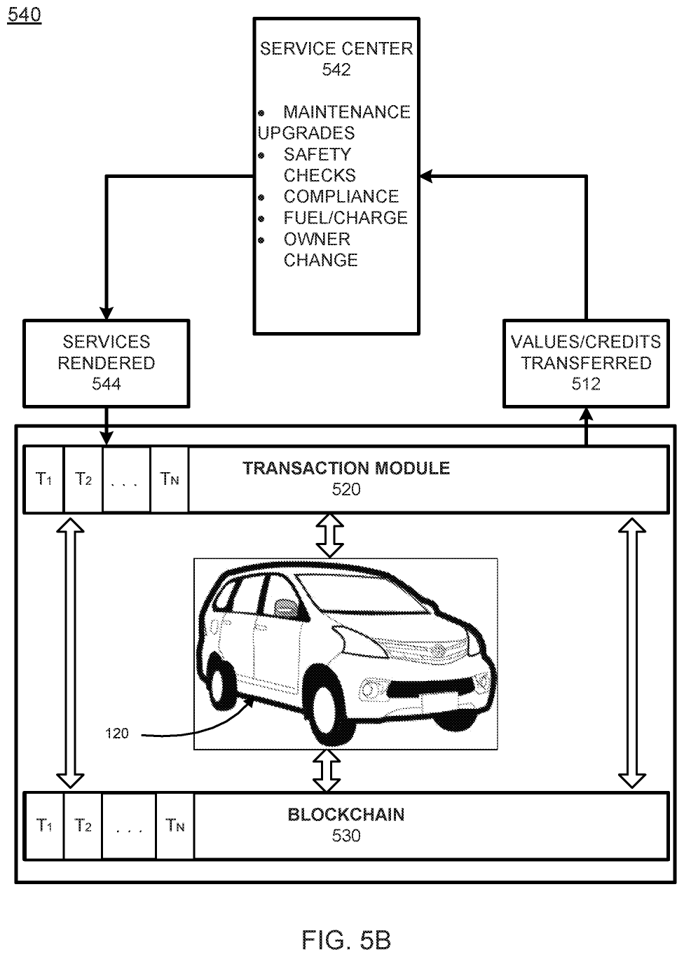

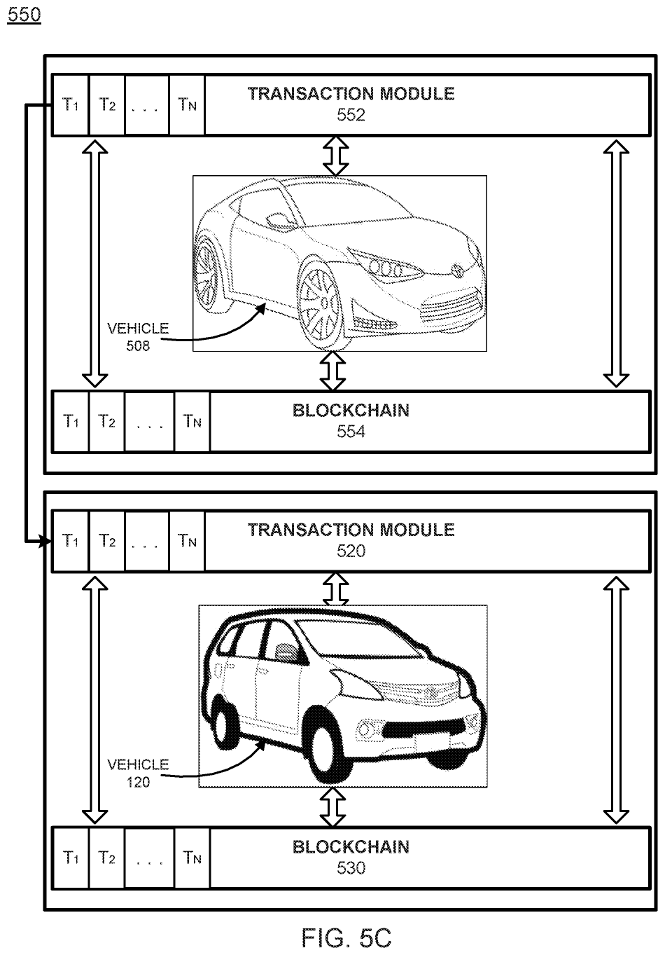

FIG. 5A illustrates an example blockchain vehicle configuration 500 for managing blockchain transactions associated with a vehicle, according to example embodiments. Referring to FIG. 5A, as a particular transport/vehicle 120 is engaged in transactions, such as service transactions (e.g., vehicle service, dealer transactions, delivery/pickup, transportation services, etc.), the vehicle may receive values 510 and/or expel/transfer values 512 according to a service transaction(s). The transaction module 520 may record information, such as parties, credits, service descriptions, date, time, location, results, notifications, unexpected events, etc. Those transactions in the transaction module 520 may be replicated into a blockchain 530 which is managed by a remote server and/or remote blockchain peers, among which the vehicle itself may represent a blockchain member and/or blockchain peer. In other embodiments, the blockchain 530 resides on the vehicle 120. When the vehicle is at the service center, in one example, the authentication and service are performed and the actions taken may be a new blockchain transaction is created based on the service, the vehicle data, the user(s) data, etc. This may be the approach taken to provide compensation for services rendered.

FIG. 5B illustrates an example blockchain vehicle configuration 540 for managing blockchain transactions between a service center and a vehicle, according to example embodiments. In this example, the vehicle 120 may have driven itself to a service center 542 (e.g., automotive dealer, local service stop, delivery pickup center, etc.) because the vehicle needs service and/or needs to stop at a particular location. The service center 542 may register the vehicle for a service call at a particular time, with a particular strategy, such as oil change, battery charge, refuel, recharge, or replacement services, such as tire change or replacement, and any other transport related service. The services rendered 544 may be performed based on a smart contract which is downloaded from or accessed via the blockchain 530 and identified for permission to perform such services for a particular rate of exchange. The services are logged in the transaction log of the transaction module 520, the credits 512 are transferred to the service center 542 and the blockchain may log transactions to represent all the information regarding the recent service. In other embodiments, the blockchain 530 resides on the vehicle 120 and/or the service center 542. In one example, a transport event may require a refuel or other vehicle service and the user may then be responsible for the responsibility value increase for such a service. The service may be rendered via a blockchain notification which is then used to redistribute the responsibility value to the user via their respective fractional responsibility values. Adherence to a regular service schedule may be part of the adherence rate or compliance necessary to achieve an optimal user vehicle status. A service stop may/may not be a permissible action permitted by a vehicle event associated with a particular occupant/target user, depending on their status. Additionally, if the vehicle prompted a user to make a service stop and the user refused, this inaction could cause a user review deduction and/or a vehicle condition deduction which is added to the overall user rating and/or damages list, which the user could be responsible for at the end of the event.

FIG. 5C illustrates an example blockchain vehicle configuration 550 for managing blockchain transactions conducted among various vehicles, according to example embodiments. The vehicle 120 may engage with another vehicle 508 to perform various actions, such as to share, transfer, acquire service calls, etc. when the vehicle has reached a status where the services need to be shared with another vehicle. For example, the vehicle 508 may be due for a battery charge and/or may have an issue with a tire and may be in route to pick up a package for delivery. The vehicle 508 may notify another vehicle 120 which is in its network and which operates on its blockchain member service. The vehicle 120 may then receive the information via a wireless communication request to perform the package pickup from the vehicle 508 and/or from a server (not shown). The transactions are logged in the transaction modules 552 and 520 of both vehicles. The credits are transferred from vehicle 508 to vehicle 120 and the record of the transferred service is logged in the blockchain 530/554 assuming that the blockchains are different from one another, or, are logged in the same blockchain used by all members. In this example, if the user was permitted to use the vehicle to perform services, such as charging another vehicle, or to perform similar actions, then the blockchain may use the smart contract to identify the terms of the agreement and ultimately log the transaction in the vehicle related blockchains as a result of having completed such tasks.

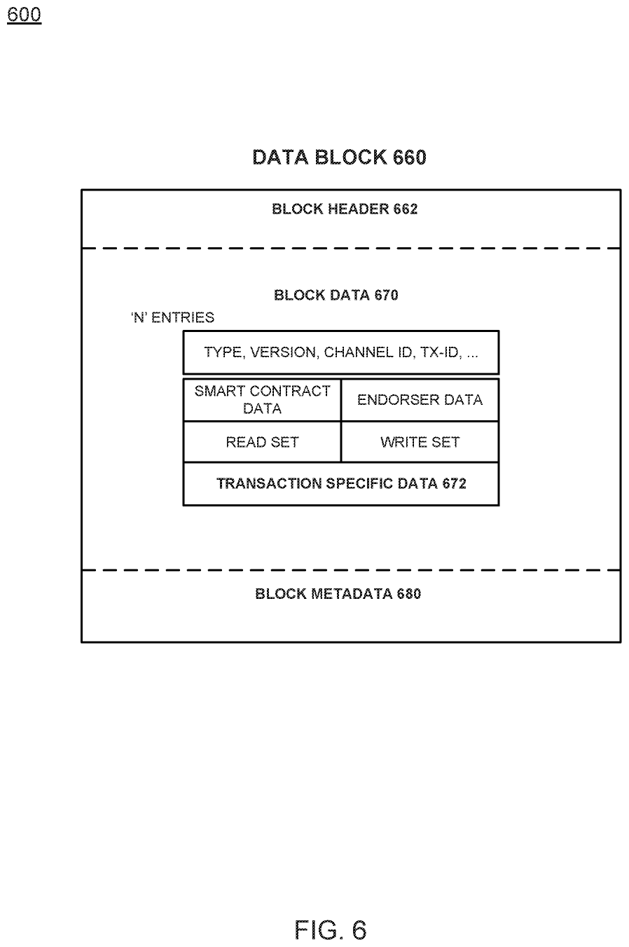

FIG. 6 illustrates a blockchain block 600 that can be added to a distributed ledger, according to example embodiments, and contents of a block structure 660. Referring to FIG. 6, clients (not shown) may submit entries to blockchain nodes to enact activity on the blockchain. As an example, clients may be applications that act on behalf of a requester, such as a device, person or entity to propose entries for the blockchain. The plurality of blockchain peers (e.g., blockchain nodes) may maintain a state of the blockchain network and a copy of the distributed ledger. Different types of blockchain nodes/peers may be present in the blockchain network including endorsing peers which simulate and endorse entries proposed by clients and committing peers which verify endorsements, validate entries, and commit entries to the distributed ledger. In this example, the blockchain nodes may perform the role of endorser node, committer node, or both.

The instant system includes a blockchain which stores immutable, sequenced records in blocks, and a state database (current world state) maintaining a current state of the blockchain. One distributed ledger may exist per channel and each peer maintains its own copy of the distributed ledger for each channel of which they are a member. The instant blockchain is an entry log, structured as hash-linked blocks where each block contains a sequence of N entries. Blocks may include various components such as those shown in FIG. 6. The linking of the blocks may be generated by adding a hash of a prior block's header within a block header of a current block. In this way, all entries on the blockchain are sequenced and cryptographically linked together preventing tampering with blockchain data without breaking the hash links. Furthermore, because of the links, the latest block in the blockchain represents every entry that has come before it. The instant blockchain may be stored on a peer file system (local or attached storage), which supports an append-only blockchain workload.

The current state of the blockchain and the distributed ledger may be stored in the state database. Here, the current state data represents the latest values for all keys ever included in the chain entry log of the blockchain. Smart contract executable code invocations execute entries against the current state in the state database. To make these smart contract executable code interactions extremely efficient, the latest values of all keys are stored in the state database. The state database may include an indexed view into the entry log of the blockchain, it can therefore be regenerated from the chain at any time. The state database may automatically get recovered (or generated if needed) upon peer startup, before entries are accepted.

Endorsing nodes receive entries from clients and endorse the entry based on simulated results. Endorsing nodes hold smart contracts which simulate the entry proposals. When an endorsing node endorses an entry, the endorsing nodes creates an entry endorsement which is a signed response from the endorsing node to the client application indicating the endorsement of the simulated entry. The method of endorsing an entry depends on an endorsement policy which may be specified within smart contract executable code. An example of an endorsement policy is “the majority of endorsing peers must endorse the entry.” Different channels may have different endorsement policies. Endorsed entries are forward by the client application to an ordering service.

The ordering service accepts endorsed entries, orders them into a block, and delivers the blocks to the committing peers. For example, the ordering service may initiate a new block when a threshold of entries has been reached, a timer times out, or another condition. In this example, blockchain node is a committing peer that has received a new data block 660 for storage on the blockchain. The ordering service may be made up of a cluster of orderers. The ordering service does not process entries, smart contracts, or maintain the shared ledger. Rather, the ordering service may accept the endorsed entries and specifies the order in which those entries are committed to the distributed ledger. The architecture of the blockchain network may be designed such that the specific implementation of ‘ordering’ (e.g., Solo, Kafka, BFT, etc.) becomes a pluggable component.

Entries are written to the distributed ledger in a consistent order. The order of entries is established to ensure that the updates to the state database are valid when they are committed to the network. Unlike a cryptocurrency blockchain system (e.g., Bitcoin, etc.) where ordering occurs through the solving of a cryptographic puzzle, or mining, in this example the parties of the distributed ledger may choose the ordering mechanism that best suits that network.

Referring to FIG. 6, a block 660 (also referred to as a data block) that is stored on the blockchain and/or the distributed ledger may include multiple data segments such as a block header 662, transaction specific data 672, and block metadata 680. It should be appreciated that the various depicted blocks and their contents, such as block 660 and its contents are merely for purposes of an example and are not meant to limit the scope of the example embodiments. In some cases, both the block header 662 and the block metadata 680 may be smaller than the transaction specific data 672 which stores entry data, however this is not a requirement. The block 660 may store transactional information of N entries (e.g., 100, 500, 1000, 2000, 3000, etc.) within the block data 670. The block 660 may also include a link to a previous block (e.g., on the blockchain) within the block header 662. In particular, the block header 662 may include a hash of a previous block's header. The block header 662 may also include a unique block number, a hash of the block data 670 of the current block 660, and the like. The block number of the block 660 may be unique and assigned in an incremental/sequential order starting from zero. The first block in the blockchain may be referred to as a genesis block which includes information about the blockchain, its members, the data stored therein, etc.

The block data 670 may store entry information of each entry that is recorded within the block. For example, the entry data may include one or more of a type of the entry, a version, a timestamp, a channel ID of the distributed ledger, an entry ID, an epoch, a payload visibility, a smart contract executable code path (deploy tx), a smart contract executable code name, a smart contract executable code version, input (smart contract executable code and functions), a client (creator) identify such as a public key and certificate, a signature of the client, identities of endorsers, endorser signatures, a proposal hash, smart contract executable code events, response status, namespace, a read set (list of key and version read by the entry, etc.), a write set (list of key and value, etc.), a start key, an end key, a list of keys, a Merkel tree query summary, and the like. The entry data may be stored for each of the N entries.

In some embodiments, the block data 670 may also store transaction specific data 672 which adds additional information to the hash-linked chain of blocks in the blockchain. Accordingly, the data 672 can be stored in an immutable log of blocks on the distributed ledger. Some of the benefits of storing such data 672 are reflected in the various embodiments disclosed and depicted herein. The block metadata 680 may store multiple fields of metadata (e.g., as a byte array, etc.). Metadata fields may include signature on block creation, a reference to a last configuration block, an entry filter identifying valid and invalid entries within the block, last offset persisted of an ordering service that ordered the block, and the like. The signature, the last configuration block, and the orderer metadata may be added by the ordering service. Meanwhile, a committer of the block (such as a blockchain node) may add validity/invalidity information based on an endorsement policy, verification of read/write sets, and the like. The entry filter may include a byte array of a size equal to the number of entries in the block data 670 and a validation code identifying whether an entry was valid/invalid.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

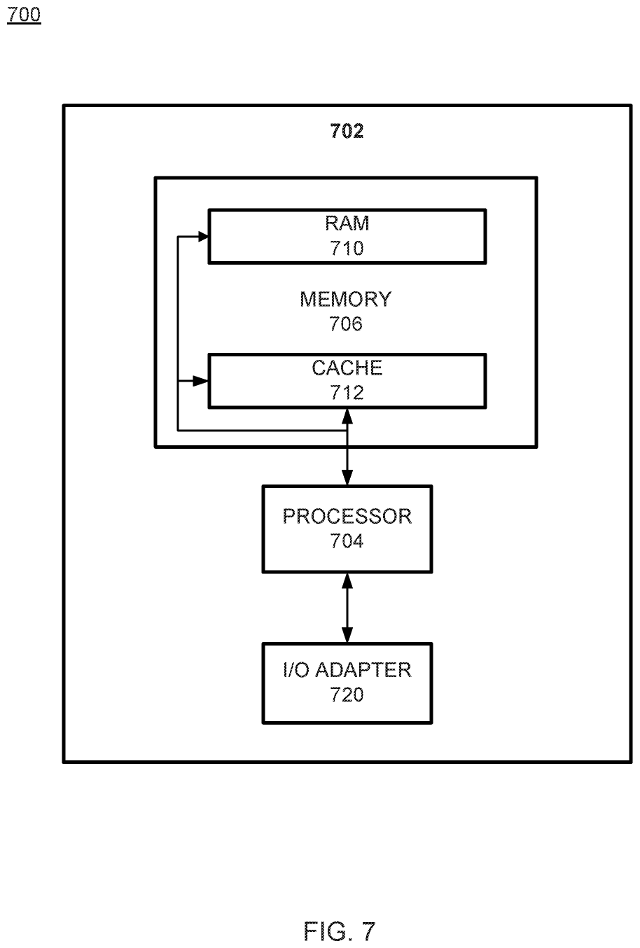

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 7 illustrates an example computer system architecture 700, which may represent or be integrated in any of the above-described components, etc.

FIG. 7 is not intended to suggest any limitation as to the scope of use or functionality of embodiments of the application described herein. Regardless, the computing node 700 is capable of being implemented and/or performing any of the functionality set forth hereinabove.

In computing node 700 there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one embodiment, implements the flow diagrams of the other figures. The system memory 706 can include computer system readable media in the form of volatile memory, such as random-access memory (RAM) 710 and/or cache memory 712. Computer system/server 702 may further include other removable/non-removable, volatile/non-volatile computer system storage media. By way of example only, memory 706 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 706 may include at least one program product having a set (e.g., at least one) of program modules that are configured to carry out the functions of various embodiments of the application.

Program/utility, having a set (at least one) of program modules, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 702 may also communicate with one or more external devices via an I/O adapter 720, such as a keyboard, a pointing device, a display, etc.; one or more devices that enable a user to interact with computer system/server 702; and/or any devices (e.g., network card, modem, etc.) that enable computer system/server 702 to communicate with one or more other computing devices. Such communication can occur via I/O interfaces of the adapter 720. Still yet, computer system/server 702 can communicate with one or more networks such as a local area network (LAN), a general wide area network (WAN), and/or a public network (e.g., the Internet) via a network adapter. As depicted, adapter 720 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
monitoring a transport for a condition level status;
determining one or more subsequent destination areas for the transport based on a current route;
determining a minimum period of time and a service type required to increase the condition level status;
identifying one or more service locations for the transport based on the condition status level, the service type and the one or more subsequent destination areas, wherein the one or more service locations have an availability to accommodate the transport for the minimum period of time; and
forwarding an updated route to the transport comprising the one or more subsequent destination areas and the one or more service locations.

2. The method of claim 1, further comprising:
receiving sensor data indicating a current battery level of a battery of the transport;
determining the condition level status, associated with the current battery level, is below a minimum threshold required for the transport to travel to a destination among the one or more subsequent destination areas identified in the current route;
determining the minimum period of time is required to charge the transport to a new battery level required to travel to the destination; and
selecting a service location among the one or more service locations which has availability for the transport to charge its battery for the minimum period of time.

3. The method of claim 1, further comprising:
transmitting a reservation request to the one or more service locations for the transport to arrive at an estimated time;
receiving a confirmation from a service location among the one or more service locations which has availability for the transport to charge its battery for the minimum period of time; and
responsive to receiving the confirmation, creating the updated route comprising the service location as a next destination.

4. The method of claim 1, further comprising:
identifying another transport with a higher charge level than a charge level of the transport;
determining the another transport has a currently availability for a transport-to-transport charging session for the minimum period of time;
assigning the another transport as a designated service location; and
creating the updated route to include the another transport's location or a meetup location where the transport and the another transport will meet, as a next destination for the transport.

5. The method of claim 4, further comprising:
receiving a transport charge from the another transport for the minimum period of time; and
creating a transaction comprising a compensation to the another transport.

6. The method of claim 1, further comprising:
retrieving a smart contract from a distributed ledger; and
identifying a compensation value from the smart contract for a charge service.

7. The method of claim 6, further comprising:
storing the blockchain transaction in the distributed ledger; and
creating a blockchain transaction when a charge service for the transport is completed, the blockchain transaction comprising parties to the transaction, a period of time of the transaction, a location and the compensation value.

8. A system, comprising:
a transport that is monitored for a condition level status; and
a server configured to:
determine one or more subsequent destination areas for the transport based on a current route;
determine a minimum period of time and a service type required to increase the condition level status;
identify one or more service locations for the transport based on the condition status level, the service type and the one or more subsequent destination areas, wherein the one or more service locations have an availability to accommodate the transport for the minimum period of time; and
forward an updated route to the transport comprising the one or more subsequent destination areas and the one or more service locations.

9. The system of claim 8, wherein the server is further configured to:
receive sensor data that indicates a current battery level of a battery of the transport;
determine the condition level status, associated with the current battery level, is below a minimum threshold required for the transport to travel to a destination among the one or more subsequent destination areas identified in the current route;
determine the minimum period of time is required to charge the transport to a new battery level required to travel to the destination; and
select a service location among the one or more service locations which has availability for the transport to charge its battery for the minimum period of time.

10. The system of claim 8, wherein the server is further configured to:
transmit a reservation request to the one or more service locations for the transport to arrive at an estimated time;
receive a confirmation from a service location among the one or more service locations which has availability for the transport to charge its battery for the minimum period of time; and
responsive to the confirmation being received, create the updated route comprising the service location as a next destination.

11. The system of claim 8, wherein the server is further configured to:
identify another transport with a higher charge level than a charge level of the transport;
determine the another transport has a currently availability for a transport-to-transport charging session for the minimum period of time;
assign the another transport as a designated service location; and
create the updated route to include the another transport's location or a meetup location where the transport and the another transport will meet, as a next destination for the transport.

12. The system of claim 11, wherein the server is further configured to:
receive a transport charge from the another transport for the minimum period of time; and
create a transaction comprising a compensation to the another transport.

13. The system of claim 8, wherein the server is further configured to:
retrieve a smart contract from a distributed ledger; and
identify a compensation value from the smart contract for a charge service.

14. The system of claim 13, wherein the server is further configured to:
store the blockchain transaction in the distributed ledger; and
create a blockchain transaction when a charge service for the transport is completed, the blockchain transaction comprising parties to the transaction, a period of time of the transaction, a location and the compensation value.

15. A non-transitory computer readable medium comprising instructions, that when read by a processor, cause the processor to perform:
monitoring a transport for a condition level status;
determining one or more subsequent destination areas for the transport based on a current route;
determining a minimum period of time and a service type required to increase the condition level status;
identifying one or more service locations for the transport based on the condition status level, the service type and the one or more subsequent destination areas, wherein the one or more service locations have an availability to accommodate the transport for the minimum period of time; and
forwarding an updated route to the transport comprising the one or more subsequent destination areas and the one or more service locations.

16. The non-transitory computer readable medium of claim 15, further comprising:
receiving sensor data indicating a current battery level of a battery of the transport;
determining the condition level status, associated with the current battery level, is below a minimum threshold required for the transport to travel to a destination among the one or more subsequent destination areas identified in the current route;
determining the minimum period of time is required to charge the transport to a new battery level required to travel to the destination; and
selecting a service location among the one or more service locations which has availability for the transport to charge its battery for the minimum period of time.

17. The non-transitory computer readable medium of claim 15, further comprising:
transmitting a reservation request to the one or more service locations for the transport to arrive at an estimated time;
receiving a confirmation from a service location among the one or more service locations which has availability for the transport to charge its battery for the minimum period of time; and
responsive to receiving the confirmation, creating the updated route comprising the service location as a next destination.

18. The non-transitory computer readable medium of claim 15, further comprising:
identifying another transport with a higher charge level than a charge level of the transport;
determining the another transport has a currently availability for a transport-to-transport charging session for the minimum period of time;
assigning the another transport as a designated service location; and
creating the updated route to include the another transport's location or a meetup location where the transport and the another transport will meet, as a next destination for the transport.

19. The non-transitory computer readable medium of claim 18, further comprising:
receiving a transport charge from the another transport for the minimum period of time; and
creating a transaction comprising a compensation to the another transport.

20. The non-transitory computer readable medium of claim 15, further comprising:
retrieving a smart contract from a distributed ledger; and
identifying a compensation value from the smart contract for a charge service.
